(19) United States
(12) Patent Application Publication
(10) Pub. No.: US 2003/0214400 A1
(43) Pub. Date: Nov. 20, 2003

(54) Monitoring system realizing high performance with reduced processing loads

(75) Inventors: Masami Mizutani, Kawasaki (JP); Kimihiko Kazui, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/419,906

(22) Filed: Apr. 22, 2003

(30) Foreign Application Priority Data
May 16, 2002 (JP) 2002-141540

(51) Int. Cl. G08B 1/00

(52) U.S. Cl. 340/531; 340/506; 348/143

(57) ABSTRACT

A monitoring system includes: monitoring terminals each having a sensor and a camera providing sensor information and image data on a monitored region, each monitoring terminal sampling and transmitting the sensor information at a first interval and at a second interval longer than the first interval, respectively; a client receiving the sensor information and the image data; and a storage server storing the sensor information and the image data. The monitoring terminals, the client, and the storage server are connected via a network. Each monitoring terminal includes: a parameter management part storing a parameter for the second interval; an abnormality detection part detecting an abnormal event; and a data amount restriction part changing the second interval when the abnormality detection part detects the sampled sensor information as the abnormal event, and starting the transmission of the sampled sensor information to the client at the changed second interval.

### BACKGROUND OF THE INVENTION

1. Field of the Invention

The present invention generally relates to monitoring systems, and more particularly to a system for monitoring a plurality of points from a remote client, the system providing the monitored points with a plurality of monitoring terminals each provided with a camera and a sensor connected thereto, connecting the monitoring terminals, the client, and a storage server via a network, and storing data on images captured by the cameras and information detected by the sensors in the storage server.

2. Description of the Related Art

There are a variety of widely known monitoring systems for performing remote monitoring on a plurality of points to be monitored. Those widely known monitoring systems include: a traffic monitoring system having a plurality of monitoring terminals provided along a road, the monitoring terminals each being connected with a camera for capturing an image of the road and a sensor for detecting the number of passing vehicles; a river monitoring system having a plurality of monitoring terminals provided along a river, the monitoring terminals each being connected with a camera for capturing an image of the river or a dam and a sensor for detecting water level, water volume, and rainfall; and a building surveillance system having a plurality of monitoring terminals provided at each floor of a building, the monitoring terminals each being connected with a camera for capturing an image of a room or stairs and a sensor for detecting intrusion, temperature, and fire. FIG. 1 is a diagram showing a well known configuration of such conventional monitoring systems. According to the configuration of FIG. 1, a monitoring terminal 51 having a sensor 55 and a camera 56 connected thereto is provided at a point to be monitored (monitored point). The monitoring terminal 51 is connected via a wired or wireless network with a client 52 provided where a monitor is stationed and a storage server 53 storing sensor information (information detected by the sensor 55) and image data (data on an image captured by the camera 56). A management server 54 stores a variety of information for the system management. The system of FIG. 1 further includes an image database (DB) 57, a sensor information database 58, a management information database 59, and a display data generation and processing part 60. The sensor 55 is configured to have characteristics corresponding to the monitored point. The monitoring terminal 51 may be connected with various types of sensors. The camera 56 is not necessarily configured to capture an image of only a fixed area. The camera 56 may have a zooming mechanism that allows the monitored region to be changed constantly or as required.

The monitoring terminal 51 transmits information detected by the sensor 55 to the client 52 and the storage server 53. Further, the monitoring terminal 51 transmits data on an image of the monitored region captured by the camera 56 to the client 52 and the storage server 53. Thereby, the image captured by the camera 56 and a graph based on the sensor information are displayed on the display unit of the client 52, so that it is monitored whether the monitored point is in an alarm state.

In the case of referring to a captured image or sensor information of the past in the client 52, the image data and the sensor information stored in the image database 57 and the sensor information database 58, respectively, of the storage server 53 can be read out to be displayed. For instance, when a request for distribution of image data is transmitted from the client 52 to the storage server 53, the image data is read out from the image database 57 to be transmitted to the client 52 so that the past image is displayed on the display unit of the client 52. When a request for reading of sensor information is transmitted from the client 52 to the management server 54, the management server 54 requests the storage server 53 to read out the sensor information so that the sensor information is read out from the sensor information database 58. Then, the display data generation and processing part 60 of the management server 54 processes the server information into such display data that can display variations in a time series order on the display unit of the client 52, and transmits the display data to the client 52.

In the above-described system, all the information detected by the sensor 55 and all the data on the images captured by the camera 56 are transmitted to the client 52. Therefore, the amount of data transmitted between the monitoring terminal 51 and the client 52 increases. Further, the client 52 processes and displays the received sensor information and image data. Therefore, the amount of data processed in the client 52 also increases. According to a well known system, the sensor information is compared with a threshold in the monitoring terminal 51, and only when the sensor information indicates an alarm state, the sensor information is transmitted to the client 52 while the image data is transmitted to the client 52 at the request thereof. Alternatively, this system may be configured so as to transmit both the sensor information and the image data indicating an alarm state.

Japanese Laid-Open Patent Application No. 7-212748 discloses a well known monitoring system that temporarily stores sensor information and image data transmitted from each monitoring terminal in a storage server, and transmits the sensor information and the image data from the storage server to a client via a network. Further, Japanese Laid-Open Patent Application No. 2000-278672 discloses a monitoring system that stores image data and sensor information on an alarm state in a monitoring terminal and transmits the image data and the sensor or alarm information via a network to a client at the request thereof.

FIG. 2 is a block diagram showing such a monitoring terminal that has the function of storing sensor information and image data. In FIG. 2, the same elements as those of FIG. 1 are referred to by the same numerals. The monitoring terminal 51 of FIG. 2 includes the sensor 55, the camera 56, an alarm management part 61, a display data generation and processing part 62, an image input part 63, a coded image storage part 64, and a communication part 65.

The alarm management part 61 compares the information detected by the sensor 55 with a threshold, and when the value of the sensor information exceeds the threshold, the alarm management part 61 determines that an alarm state has occurred. When the occurrence of an alarm state is detected, the display data generation and processing part 62 is activated to generate such display data that can be displayed on the client side. Further, the image input part 63 converts the analog signal of data on an image of the monitored region captured by the camera 56 into a digital image signal. The coded image storage part 64 stores the compressed and encoded image data. At the request of the client, the communication part 65 transmits to the client the display data (processed so that the sensor information can be displayed) including the alarm information. In this case, generally, the client makes a distribution request at regular intervals.

### SUMMARY OF THE INVENTION

In a relatively large-scale monitoring system, the number of monitoring terminals may reach a few hundred or more. The client 52 having the multiple monitoring terminals 51 connected thereto via a network processes the sensor information and the image data transmitted from each monitoring terminal 51 and displays the transmitted sensor information and image data on its display unit. Accordingly, the amount of data processed by the client 52 increases. Therefore, in the system where all of the sensor information and the image data are transmitted from each monitoring terminal 51 to the client 52, the amount of transmitted data increases, so that the scale of the network should be enlarged and the performance of the client 52 should be enhanced. This, however, entails the problem of an increase in the cost of the system.

In a system, the client 52 makes a distribution request to the monitoring terminal 51 at predetermined regular intervals and the monitoring terminal 51, which, for instance, generates and stores image data in the coded image storage part 64 and display data in the display data generation and processing part 62 as shown in FIG. 2, transmits the image data and the display data to the client 52 at the request thereof, so that the amount of transmitted data and the amount of data processed in the client 52 are reduced. In such a system, however, there is the problem of the time lag between the occurrence of an alarm state at the monitored point and the recognition of the alarm state by the client 52. Further, the scale of the monitoring terminal 51 is relatively large, so that the cost of the system increases if the system employs a large number of monitoring terminals 51.

Further, in the conventional monitoring system where a storage part is provided not inside but outside the monitoring terminal 51 as the storage server 53 so as to store the sensor information and the image data as shown in FIG. 1, the sensor information and the image data are transmitted by the same method to the client 52 and the storage server 53. Accordingly, in the case of storing the detailed sensor information in the storage server 53 by sampling the sensor information at reduced intervals (increased frequency), the amount of data transmitted to the client 52 increases, thus causing the problem of an increase in the amount of data processed in the client 52 as previously described. However, if the amount of data transmitted to the client 52 is reduced, it means that the sensor information is sampled at increased intervals (reduced frequency), so that the accuracy of the sensor information stored in the storage server 53 is decreased. This makes it difficult to analyze the cause of an alarm state with respect to the sensor information.

Accordingly, it is a general object of the present invention to provide a monitoring system in which the above-described disadvantages are eliminated.

A more specific object of the present invention is to provide a monitoring system that can reduce the amount of processing in a client, store highly-accurate sensor information, and immediately notify the client of the detection of an alarm state.

The above objects of the present invention are achieved by a monitoring system including: one or more monitoring terminals each connected to a sensor and a camera providing sensor information and image data, respectively, on a monitored region, the monitoring terminals each sampling and transmitting the sensor information at first and second intervals, respectively, the second interval being longer than the first interval; a client receiving the sensor information and the image data and displaying a state of the monitored region; and a storage server storing the sensor information and the image data, wherein: the monitoring terminals, the client, and the storage server are connected via a network; and the monitoring terminals each include: a parameter management part storing a parameter for the second interval; an abnormality detection part detecting an abnormal event by comparing a value of the sampled sensor information with a threshold; and a data amount restriction part changing the second interval when the abnormality detection part detects the sampled sensor information as the abnormal event, and starting the transmission of the sampled sensor information to the client at the changed second interval.

The above objects of the present invention are also achieved by a monitoring method employing: one or more monitoring terminals each connected to a sensor and a camera providing sensor information and image data, respectively, on a monitored region, the monitoring terminals each sampling and transmitting the sensor information at first and second intervals, respectively, the second interval being longer than the first interval; a client receiving the sensor information and the image data and displaying a state of the monitored region; and a storage server storing the sensor information and the image data, the monitoring terminals, the client, and the storage server being connected via a network, the monitoring method including the steps of: (a) the monitoring terminals each detecting an abnormal event by comparing a value of the sampled sensor information with a threshold; and (b) the monitoring terminals each changing the second interval when the step (a) detects the sampled sensor information as the abnormal event, and starting the transmission of the sampled sensor information to the client at the changed second interval.

The above objects of the present invention are further achieved by a monitoring apparatus connected to a sensor and a camera providing sensor information and image data, respectively, on a monitored region, the monitoring apparatus sampling and transmitting the sensor information at first and second intervals, respectively, the second interval being longer than the first interval, the monitoring apparatus including: a parameter management part storing a parameter for the second interval; an abnormality detection part detecting an abnormal event by comparing a value of the sampled sensor information with a threshold; and a data amount restriction part changing the second interval when the abnormality detection part detects the sampled sensor information as the abnormal event, and starting the transmission of the sampled sensor information at the changed second interval.

According to the present invention, the monitoring terminals each connected with the sensor and the camera are provided at a plurality of monitored regions so as to be connected with the client and the storage server via a network. Each of the monitoring terminals transmits the sensor information sampled at the first interval to the client at the second interval larger than the first interval, thereby reducing the amount of data transmitted to the client and the processing load on the client. Thereby, the client is allowed to receive the sensor information and the image data supplied from the monitoring terminals without increasing its processing capacity. That is, the monitoring system of the present invention can be reduced in cost compared with a conventional monitoring system of the same scale.

### BRIEF DESCRIPTION OF THE DRAWINGS

Other objects, features and advantages of the present invention will become more apparent from the following detailed description when read in conjunction with the accompanying drawings, in which:

FIG. 1 is a diagram showing a conventional monitoring system;

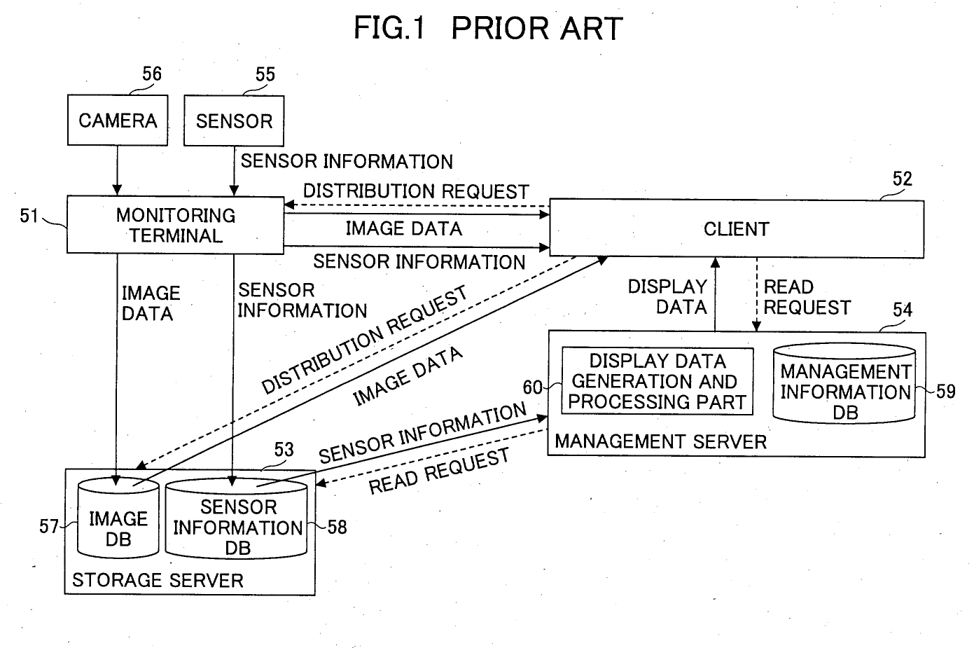

FIG. 2 is a diagram showing a monitoring terminal employed in the conventional monitoring system;

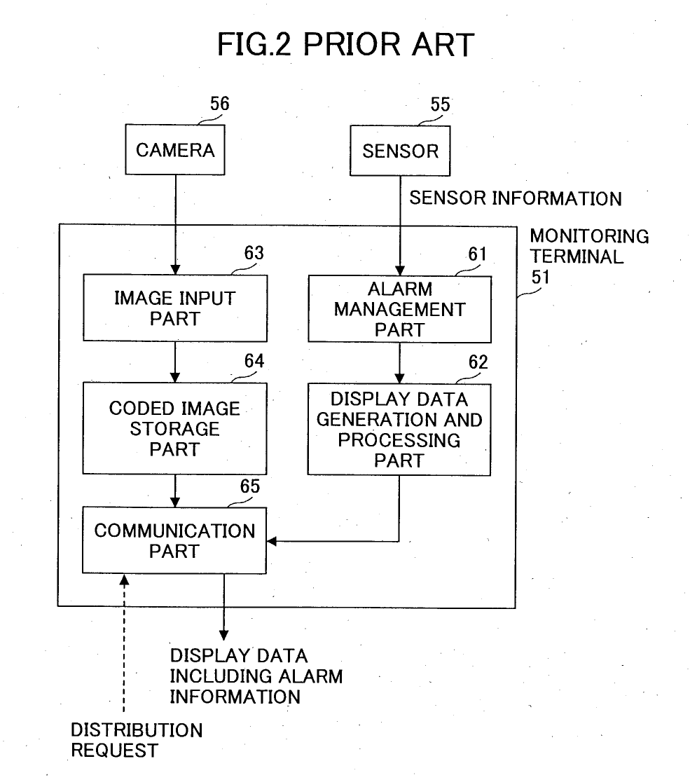

FIG. 3 is a diagram showing a monitoring system according to an embodiment of the present invention;

FIG. 4 is a diagram showing a monitoring terminal according to the embodiment of the present invention;

FIGS. 5A and 5B are diagrams for illustrating transmission control of sensor information and image data according to the embodiment of the present invention; and

FIG. 6 is a diagram for illustrating display contents of a display unit of a client according to the embodiment of the present invention.

### DETAILED DESCRIPTION OF THE PREFERRED EMBODIMENTS

A description will now be given, with reference to the accompanying drawings, of an embodiment of the present invention.

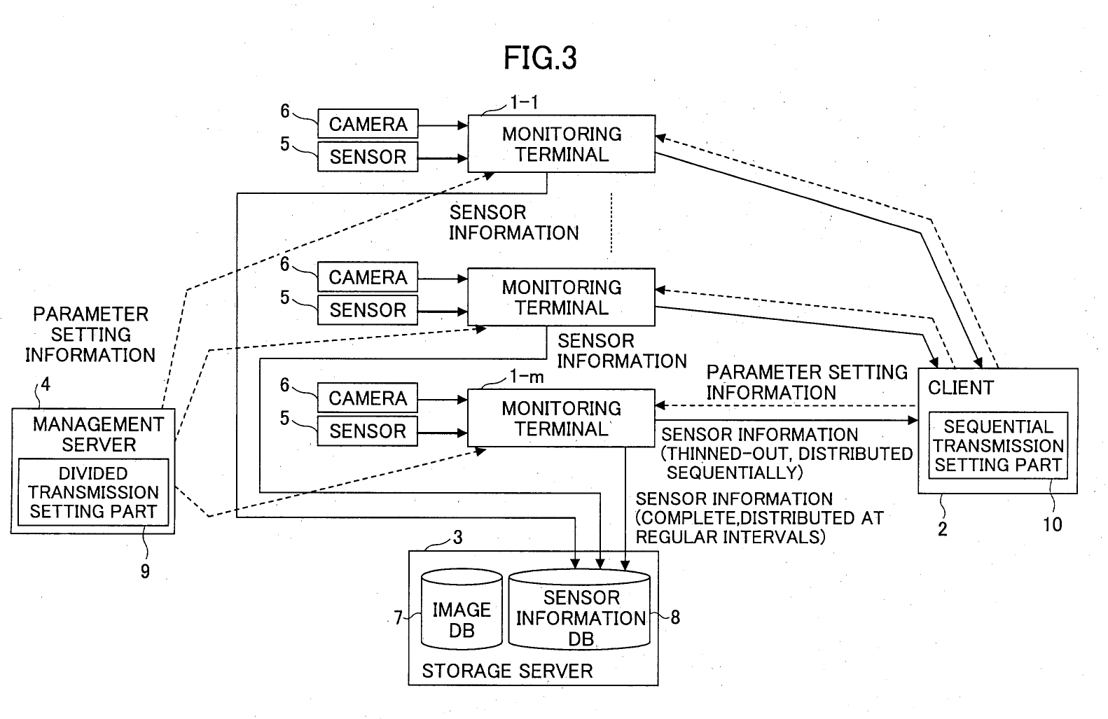

FIG. 3 is a diagram showing a monitoring system according to the embodiment of the present invention. The monitoring system includes a plurality of monitoring terminals 1-1 through 1-m provided at points to be monitored (monitored points), a client (or clients) 2 for performing remote monitoring, a storage server 3, a management server 4, sensors 5, cameras 6, an image database 7, a sensor information database 8, a divided transmission setting part 9, and a sequential transmission setting part 10. The monitoring system is formed by connecting the monitoring terminals 1-1 through 1-m, the client(s) 2, the storage server 3, and the management server 4 by a network. In FIG. 3, a transmission channel for sensor information (information detected by the sensors 5) is indicated by the solid arrows, and a transmission channel for parameter setting information (information on the settings of parameters) is indicated by the broken arrows. Although a transmission channel for image data (data on the images captured by the cameras 6) is not shown in the drawing, the image data is transmitted through the same network as the sensor information. The sensors 5 may be various types of sensors detecting temperature, water level, rainfall, sound volume, traffic, smoke, and gas in accordance with the monitored points.

Each of the monitoring terminals 1-1 through 1-m is connected with the camera 6 and the sensor 5. Each of the monitoring terminals 1-1 through 1-m may be connected with the sensors 5 of a plurality of types instead of the single sensor 5. Each of the monitoring terminals 1-1 through 1-m transmits the data on an image of the monitored region captured by the camera 6 (the image data) and the information detected by the sensor 5 (the sensor information) in the monitored region to the client 2 and the storage server 3 in accordance with parameters set respectively therefor. The client 2 includes a display unit (not shown in the drawing) and the sequential transmission setting part 10. The sequential transmission setting part 10 has the function of sequentially transmitting to the monitoring terminals 1-1 through 1-m parameter setting information as to a sampling interval, a threshold for detecting an abnormal event (or an alarm state), and the starting and suspending of information distribution.

As conventionally, the storage server 3 includes the image database 7 and the sensor information database 8. The management server 4 has the function of performing parameter setting and management on the monitoring terminals 1-1 through 1-m so that the monitoring terminals 1-1 through 1-m perform basic operations of the system. The divided transmission setting part 9 of the management server 4 has the function of transmitting to the monitoring terminals 1-1 through 1-m parameter setting information as to time divisions according to which the sensor information (and the image data) is collectively transmitted to the storage server 3 and the starting and suspending of divided transmission of the sensor information.

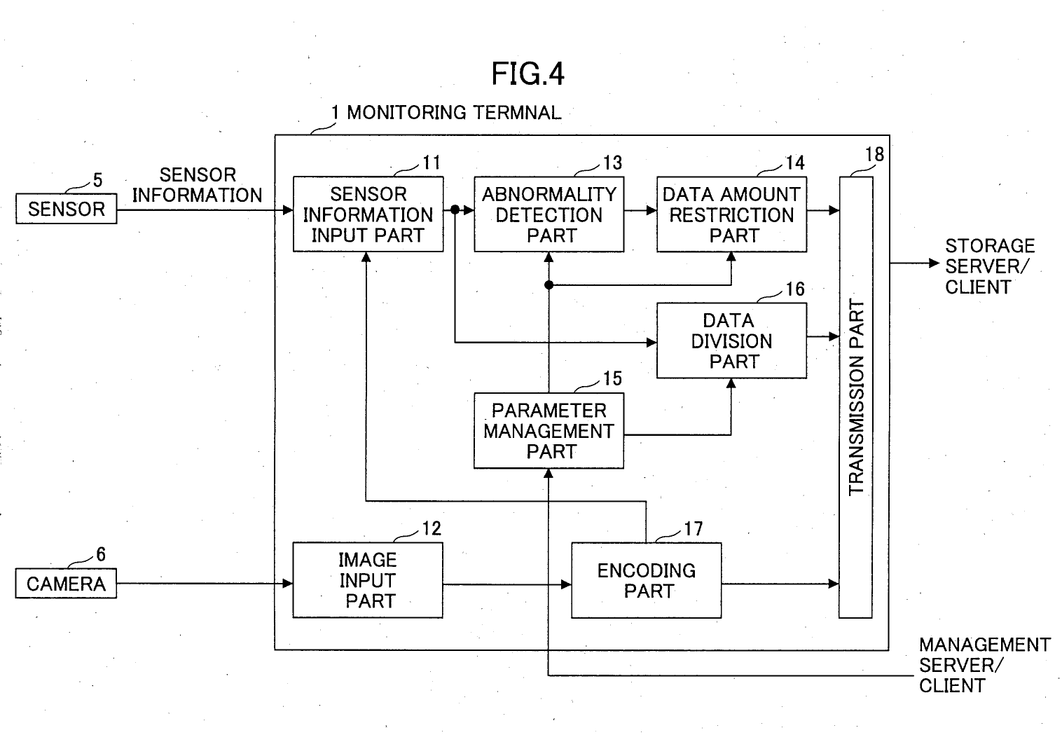

FIG. 4 is a diagram showing any of the monitoring terminals 1-1 through 1-m according to the embodiment of the present invention. In the following description, the monitoring terminal is referred to by reference numeral 1 for convenience of description. The monitoring terminal 1 has the sensor 5 and the camera 6 connected thereto. Further, the monitoring terminal 1 includes a sensor information input part 11, an image input part 12, an abnormality detection part 13, a data amount restriction part 14, a parameter management part 15, a data division part 16, a encoding part 17, and a transmission part 18.

The parameter management part 15 receives the parameter setting information transmitted from the client 2 and the management server 4 via the network as previously described. For instance, the parameter management part 15 sets intervals at which the sensor information detected by the sensor 5 to be input to the sensor information input part 11 successively in a time series is sampled. Further, the parameter management part 15 sets a threshold for detecting an abnormal event in the abnormality detection part 13. The abnormality detection part 13 determines that an abnormal event (an alarm state) has occurred when the value of the sensor information exceeds the set threshold. When the sensor information falls below the threshold, the abnormality detection part 13 determines and notifies the data amount restriction part 14 that the abnormal event is over.

Further, with respect to the parameter setting information as the sampling interval and the starting and suspending of information distribution, the parameter management part 15 sets in the data amount restriction part 14 a sampling or transmission interval for transmission to the client 2 which transmission interval is longer than the sampling interval for sampling the sensor information. With respect to the sensor information (and the image data) to be transmitted to the storage server 3, the parameter management part 15 provides a setting such that the sensor information is collectively transmitted every time division. That is, the sensor information is transmitted to the client 2 at intervals according to the transmission interval, and when an abnormal event occurs, the sensor information at the time of its occurrence is transmitted to the client 2 so as to eliminate delay in recognizing the occurrence of the abnormal event in the client 2. Further, when the sensor information falls below the threshold, the sensor information at this point is also transmitted to the client 2, notifying the client 2 of the end of the abnormal event. Accordingly, the client 2 can immediately recognize the occurrence and the end of the abnormal event.

A motion vector in the process of compression and encoding in the encoding part 17 is obtained in accordance with a time series, so that it is possible to handle the motion vector as a kind of sensor information. For instance, a large motion vector indicates a large movement and a great variation in the monitored region. Therefore, the motion vector can be employed as sensor information indicating the state where a fluid rate variation is increased, for instance.

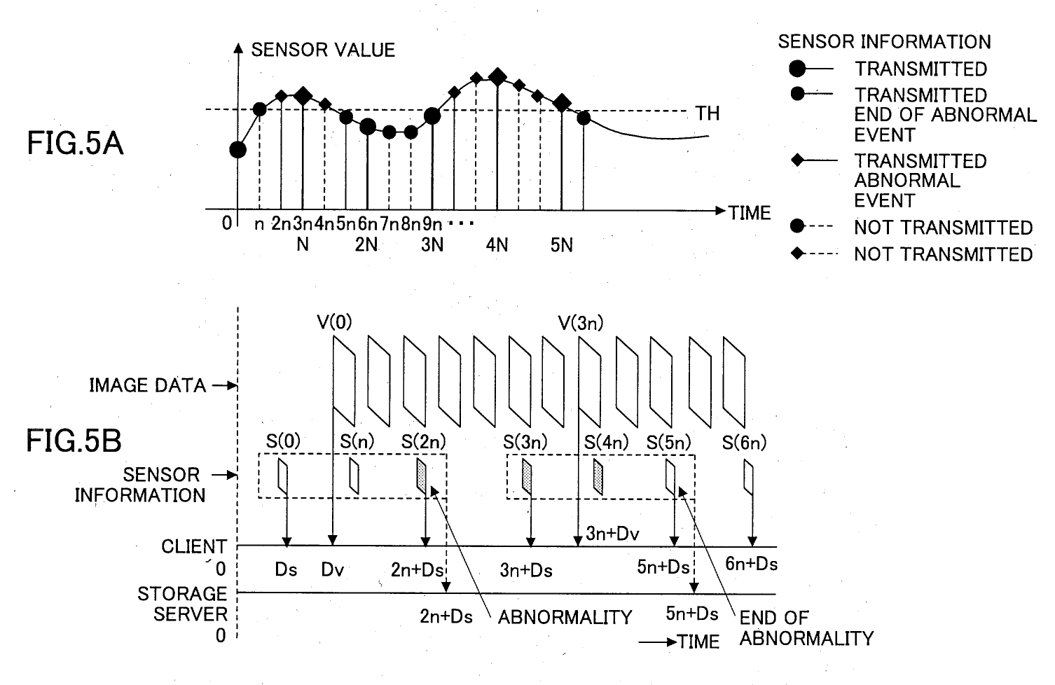

FIGS. 5A and 5B are diagrams showing a control operation of transmission of the sensor information compared with the threshold in the monitoring terminal 1, the sensor information (and the image data) to be transmitted to the client 2, and the sensor information (and the image data) to be transmitted to the storage server 3. FIG. 5A shows the sensor information, and FIG. 5B shows timing for transmitting the image data and the sensor information to the client 2 and the storage server 3. Each sampling interval of the sensor information is n, each transmission interval of the sensor information to the client 2 is N, and the threshold is indicated by TH.

The sensor information input part 11 of the monitoring terminal 1 samples the sensor information sequentially in a time series supplied from the sensor 5 detecting temperature or water level at sampling instants 0, n, 2n, 3n, . . . , and inputs the sampled sensor information to the abnormality detection part 13 and the data division part 16. The sensor information, abnormal event detection information, and abnormal event end detection information are supplied from the abnormality detection part 13 to the data amount restriction part 14. When the value of the sensor information does not exceed the threshold TH, the data amount restriction part 14 transmits the sensor information at the transmission interval N between transmission instants 0, N, 2N, 3N, . . . from the transmission part 18 to the client 2. In other words, the sensor information is transmitted to the client 2 in timing with the instants 0, N, 2N, 3N, . . . spaced at longer intervals than the sampling instants n, 2n, 3n, . . . . The transmission instants 0, N, 2N, 3N, . . . are indicated by the bold solid lines in FIG. 5A. Thus, the sampled sensor information is thinned out and transmitted to the client 2.

According to FIG. 5A, the value of the sensor information exceeds the threshold TH at the instant 2n next to the instant n. Then, the abnormality detection part 13 determines that an abnormal event has occurred, and notifies the data amount restriction part 14 of the occurrence of the abnormal event. Due to the detection of the occurrence of the abnormal event, the data amount restriction part 14 transmits the sensor information of this point, that is, of the instant 2n, to the client 2 although it is before the next transmission instant N. Thereby, the client 2 can immediately recognize the occurrence of the abnormality in the monitored region.

Since the next (sampling) instant 3n coincides with the transmission instant N, the sensor information of the instant 3n is unconditionally transmitted to the client 2. At the next instant 4n, the value of the sensor information still exceeds the threshold TH. The sensor information does not indicate the end of the abnormal event, nor is the instant 4n a transmission instant of the sensor information. Therefore, the sensor information of the instant 4n is not transmitted to the client 2.

At the next instant 5n, the sensor information falls below the threshold TH, indicating the end of the abnormal event. Therefore, the sensor information of the instant 5n is transmitted to the client 2 although the instant 5n is not a transmission instant at which the sensor information is normally transmitted to the client 2. The next instant 6n coincides with the transmission instant 2N. Therefore, the sensor information of the instant 6n is transmitted to the client 2. That is, by transmitting the sensor information to the client 2 at the transmission interval N that is longer than the sampling interval n of the sensor information, the amount of transmitted data can be reduced. Further, when an abnormal event whose value exceeds the threshold TH occurs, the sensor information of the instant of the occurrence of the abnormal event is transmitted to the client 2 even though the instant of the occurrence of the abnormal event is not a transmission instant at which the sensor information is normally transmitted to the client 2. Thereafter, the sensor information of the instant of the end of the abnormal information is transmitted to the client 2. Accordingly, no sensor information is transmitted to the client 2 at the instants indicated by the broken lines in FIG. 5A.

In FIG. 5B, delay in transmitting the sensor information is indicated by Ds, and delay in transmitting the image data is indicated by Dv. Further., the image data and the sensor information at an instant (timing) t are indicated by V(t) and S(t), respectively. The delay Dv corresponds to delay caused by compressing and encoding the image data in the encoding part 17. The delay Ds corresponds to delay caused by processing in the sensor information input part 11 and the abnormality detection part 13.

With respect to the sensor information S(0), S(n), S(2n), S(3n), . . . at the sampling instants 0, n, 2n, 3n, . . . in FIG. 5A, first, the sensor information S(0) and the image data V(0) are transmitted to the client 2 with the delays Ds and Dv, respectively, from the sampling instant 0. Since the instant n is not a transmission instant, the sensor information S(n) is not transmitted to the client 2. The sensor information S(2n) of the next instant 2n indicates the occurrence of the abnormal event whose value exceeds the threshold TH as shown in FIG. 5A. Therefore, the sensor information S(2n) is transmitted to the client 2 although the instant 2n is not a transmission instant. There is a difference of 2n+Ds between the instant 0 and the time at which the sensor information S(2n) is transmitted to the client 2.

FIG. 5B shows the case where three pieces of the sensor information are collectively transmitted to the storage server 3. The sensor information S(0), S(n), and S(2n) is collectively transmitted to the storage server 3 at the time of 2n+Ds from the instant 0. That is, the sensor information S(0), S(n), and S(2n) enclosed by a broken-line is collected by the control of the data division part 16 and is transmitted to the storage server 3 by the control of the transmission part 18. The sensor information S(3n) and the image data V(3n) of the next instant 3n are unconditionally transmitted to the client 2 at a time of 3n+Ds and a time of 3n+Dv, respectively, since the instant 3n is a transmission instant.

By thus thinning out the sensor information sampled at the sampling interval n so that the sensor information is transmitted to the client 2 at the transmission interval N larger than the sampling interval n, the amount of data transmitted to the client 2 can be reduced. Further, a predetermined number of pieces of the sensor information sampled at the sampling interval n is collected and transmitted to the storage server 3 every time division, so that the sensor information can be stored in a time series in the sensor information database 8. Therefore, in the case of the occurrence of an abnormal event, the abnormal event can be analyzed using the highly accurate sensor information.

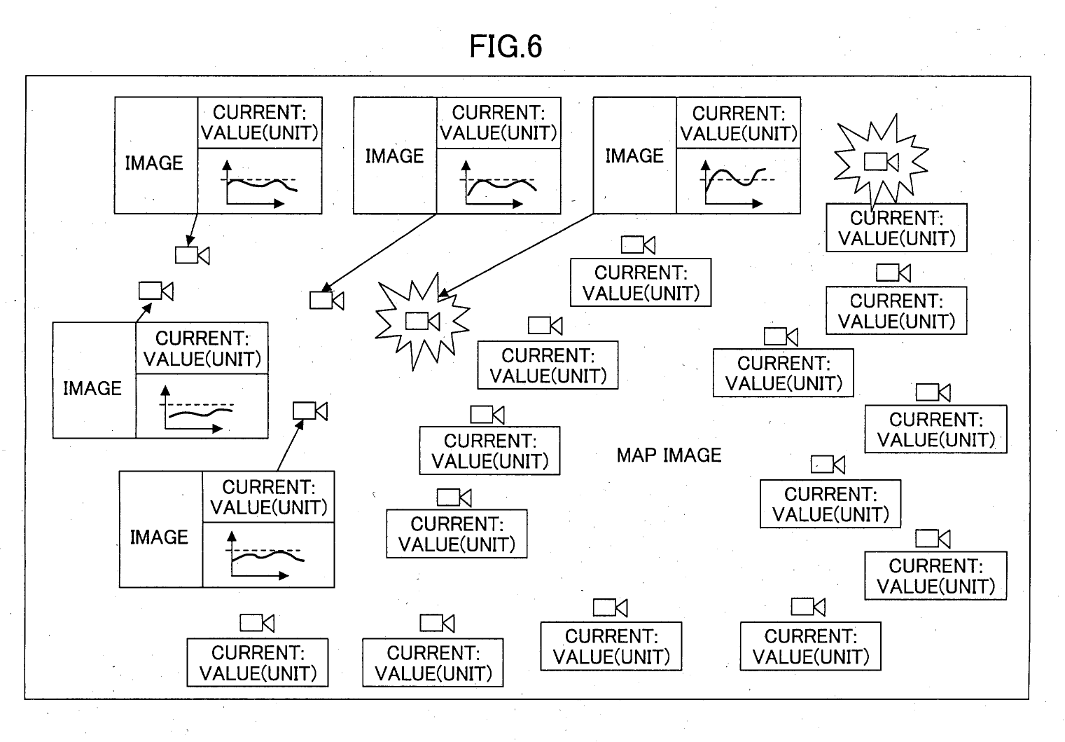

FIG. 6 is a schematic diagram showing display contents of the display unit of the client 2 according to the embodiment of the present invention. According to FIG. 6, the monitoring terminals 1 provided at k monitored points are displayed on a map image with respective names and numbers. In the case of the occurrence of an abnormal event, the monitoring terminal 1 detecting the occurrence of the abnormal event is displayed flickering or reversed so as to be distinguished from the other monitoring terminals 1. An image captured by the camera 6 of the monitoring terminal 1 can be displayed on a region shown as an image in FIG. 6. The sensor information around the occurrence of the abnormal event can be read out from the storage server 3 so as to be displayed as a graph. Further, the image of the monitored region before the occurrence of the abnormal event or from the occurrence or start until the end of the abnormal event can be displayed. Thereby, the process of the occurrence of the abnormal event can be analyzed. Alternatively, the sensor information and/or the image data stored in the storage server 3 can be read out to be displayed as required.

If the client 2 is capable of receiving the sensor information sampled at the sampling interval n from each of the k monitoring terminals 1, then it is possible to increase the number of monitoring terminals 1 that can be processed by the client 2 to k×N/n on condition that the sensor information is transmitted from each monitoring terminal 1 at the transmission interval N larger than the sampling interval n as previously described. Further, the storage server 3 stores the sensor information sampled at the sampling interval n. Therefore, the sensor information can be analyzed without any loss of accuracy. Further, the transmission interval N may be set differently in each of the monitoring terminals 1. Furthermore, the reference sampling instant 0 in FIGS. 5A and 5B may be set differently in each of the monitoring terminals 1 so as to prevent the monitoring terminals 1 from transmitting the sensor information to the client 2 in the same timing. This makes it easy for the client 2 to receive the sensor information.

As described above, according to the monitoring system of the present invention, the monitoring terminals 1-1 through 1-m each connected with the sensor 5 and the camera 6 are provided at a plurality of monitored regions so as to be connected with the client 2 and the storage server 3 via a network. Each of the monitoring terminals 1-1 through 1-m transmits the sensor information sampled at the sampling interval n to the client 2 at the transmission interval N larger than the sampling interval n, thereby reducing the amount of data transmitted to the client 2 and the processing load on the client 2. Thereby, the client 2 is allowed to receive the sensor information and the image data supplied from the monitoring terminals 1 without increasing its processing capacity. That is, the monitoring system of the present invention can be reduced in cost compared with a conventional monitoring system of the same scale.

Further, when the sensor information exceeding the threshold in value is detected by the abnormality detection part 13 of any of the monitoring terminals 1-1 through 1-m, the sensor information detected at this point is transmitted to the client 2 as the occurrence of an abnormal event. When the end of the abnormal event is detected, the sensor information detected at this point is also transmitted to the client 2. Accordingly, the client 2 can immediately recognize the occurrence and the end of the abnormal event. Further, the storage server 3 can store the sensor information sampled at the sampling interval n by each of the monitoring terminals 1-1 through 1-m. Therefore, the cause of the occurrence of the abnormal event can be analyzed easily based on the sensor information stored in the storage server 3. Further, the sensor information is collectively transmitted each time division from each of the monitoring terminals 1-1 through 1-m. Therefore, the processing loads on the monitoring terminals 1-1 through 1-m and the storage server 3 can be reduced.

The present invention is not limited to the specifically disclosed embodiment, but variations and modifications may be made without departing from the scope of the present invention.

The present application is based on Japanese priority application No. 2002-141540 filed on May 16, 2002, the entire contents of which are hereby incorporated by reference.

What is claimed is:

1. A monitoring system comprising:
one or more monitoring terminals each connected to a sensor and a camera providing sensor information and image data, respectively, on a monitored region, the monitoring terminals each sampling and transmitting the sensor information at first and second intervals, respectively, the second interval being longer than the first interval;
a client receiving the sensor information and the image data and displaying a state of the monitored region; and
a storage server storing the sensor information and the image data,
wherein:
said monitoring terminals, said client, and said storage server are connected via a network; and
said monitoring terminals each comprise:
a parameter management part storing a parameter for the second interval;
an abnormality detection part detecting an abnormal event by comparing a value of the sampled sensor information with a threshold; and
a data amount restriction part changing the second interval when said abnormality detection part detects the sampled sensor information as the abnormal event, and starting the transmission of the sampled sensor information to said client at the changed second interval.

2. The monitoring system as claimed in claim 1, wherein:
said abnormality detection part detects an occurrence of the abnormal event when the value of the sampled sensor information exceeds the threshold and an end of the abnormal event when the value of the obtained sensor information falls below the threshold; and
said data amount restriction part changes the second interval when said abnormality detection part detects the sampled sensor information as the occurrence or the end of the abnormal event.

3. The monitoring system as claimed in claim 1, further comprising a data division part collecting a predetermined number of pieces of each of the sensor information and the image data sampled at the first interval, and transmitting the collected pieces of the sampled information and image data to said storage server.

4. The monitoring system as claimed in claim 1, wherein said client comprises a parameter setting part setting the second interval in said parameter management part of each of said monitoring terminals.

5. The monitoring system as claimed in claim 4, wherein said parameter setting part of said client sets the second interval differently in said parameter management part of each of said monitoring terminals.

6. The monitoring system as claimed in claim 1, wherein said client further comprises a parameter setting part setting the threshold in said parameter management part of each of said monitoring terminals.

7. The monitoring system as claimed in claim 1, further comprising a management server setting time divisions according to which the sensor information is transmitted from said monitoring terminals to said storage server in said parameter management part of each of said monitoring terminals.

8. A monitoring method employing: one or more monitoring terminals each connected to a sensor and a camera providing sensor information and image data, respectively, on a monitored region, the monitoring terminals each sampling and transmitting the sensor information at first and second intervals, respectively, the second interval being longer than the first interval; a client receiving the sensor information and the image data and displaying a state of the monitored region; and a storage server storing the sensor information and the image data, the monitoring terminals, the client, and the storage server being connected via a network, the monitoring method comprising the steps of:
(a) the monitoring terminals each detecting an abnormal event by comparing a value of the sampled sensor information with a threshold; and
(b) the monitoring terminals each changing the second interval when said step (a) detects the sampled sensor information as the abnormal event, and starting the transmission of the sampled sensor information to the client at the changed second interval.

9. The monitoring method as claimed in claim 8, wherein:
said step (a) detects an occurrence of the abnormal event when the value of the sampled sensor information exceeds the threshold and an end of the abnormal event when the value of the obtained sensor information falls below the threshold; and
said step (b) changes the second interval when said step (a) detects the sampled sensor information as the occurrence or the end of the abnormal event.

10. The monitoring method as claimed in claim 8, further comprising the step of (c) collecting a predetermined number of pieces of each of the sensor information and the image data sampled at the first interval, and transmitting the collected pieces of the sampled information and image data to the storage server.

11. The monitoring method as claimed in claim 8, further comprising the step of (c) the client setting the second interval in the parameter management part of each of the monitoring terminals.

12. The monitoring method as claimed in claim 11, wherein said step (c) sets the second interval differently in the parameter management part of each of the monitoring terminals.

13. The monitoring method as claimed in claim 8, further comprising the step of (c) setting the threshold in the parameter management part of each of the monitoring terminals.

14. The monitoring method as claimed in claim 8, further comprising the step of (c) setting time divisions according to which the sensor information is transmitted from the monitoring terminals to the storage server in the parameter management part of each of the monitoring terminals.

15. A monitoring apparatus connected to a sensor and a camera providing sensor information and image data, respectively, on a monitored region, the monitoring apparatus sampling and transmitting the sensor information at first and second intervals, respectively, the second interval being longer than the first interval, the monitoring apparatus comprising:
a parameter management part storing a parameter for the second interval;
an abnormality detection part detecting an abnormal event by comparing a value of the sampled sensor information with a threshold; and
a data amount restriction part changing the second interval when said abnormality detection part detects the sampled sensor information as the abnormal event, and starting the transmission of the sampled sensor information at the changed second interval.
